(19) United States
(12) Patent Application Publication
(10) Pub. No.: US 2003/0182201 A1
(43) Pub. Date: Sep. 25, 2003

(54) Delivery optimization system and method

(76) Inventor: Ung-Ryul Lee, Seoul (KR)

Correspondence Address: CHRISTIE, PARKER & HALE, LLP, 350 WEST COLORADO BOULEVARD, SUITE 500, PASADENA, CA, 91105, US

(21) Appl. No.: 10/240,147

(22) PCT Filed: Mar. 28, 2001
(86) PCT No.: PCT/KR01/00506

(30) Foreign Application Priority Data
Mar. 28, 2000 (KR) 2000-0015847

(51) Int. Cl. G06F 17/60

(52) U.S. Cl. 705/26

(57) ABSTRACT

Disclosed is a system and method for delivering a shopping item to a purchaser in the most rapid and inexpensive way by presenting optimum product price, delivery means, delivery rate and delivery time based on the type and quantity of the shopping item and a desired delivery destination. The delivery optimization system, in which a purchaser accesses a network via a computer to input shopping items and quantity of the items, includes: a shopping mall providing server for receiving shopping items and quantity of items input by the purchaser, and providing a shopping mall that enables the purchaser to execute a commercial transaction; a delivery information database for storing delivery information including delivery methods and delivery rates of the items provided in the shopping mall; and a delivery method decision agent for determining an optimum delivery method using the delivery information of the delivery information database when the purchaser chooses the delivery method of the shopping item.

### BACKGROUND OF THE INVENTION

(a) Field of the Invention

The present invention relates to a delivery optimization system and method. More specifically, the present invention relates to a system and method for delivering a shopping item to a purchaser in an extremely rapid and inexpensive way by presenting optimum product price, delivery means, delivery rate and delivery time based on the type and quantity of the shopping item and a desired destination.

(b) Description of the Related Art

With the recent explosive growth in electronic commercial transaction services, many companies have contrived a variety of ideas for presenting a low shopping price in order to attract more purchasers to the transaction sites concerned. These existing electronic commercial transaction sites are provided primarily for transactions between companies and persons, so that large quantities of items are seldom marketed and purchased. For that reason, a large part of the payment is spent on the price of the item and the delivery rate is relatively small. For example, the total shopping price has been reduced in such a manner that an additional delivery rate of 3,000 won (Korean currency) is charged to the purchaser who buys three or less pieces of an item, but the delivery rate is exempted when the purchaser buys at least four pieces of the item. However, products of large quantities are marketed and purchased in transactions between companies that are expected to become the major part of electronic commercial transactions, in which case the delivery rate is not negligible in the total shopping price. Accordingly, there is a need for delivery optimization for transactions where the delivery rate is a large part of the shopping price, for example, by presenting reasonable delivery rates and time that satisfy the demands of the purchaser.

### SUMMARY OF THE INVENTION

It is an object of the present invention to solve the problem and to provide a system and method for optimizing delivery rate and time that are not negligible in large electronic commercial transactions between companies on the Internet, in contrast to the conventional transactions between companies and persons that involve a low delivery rate.

In one aspect of the present invention, there is provided a delivery optimization system that includes client computers that drive a web browser, a shopping mall providing server, a delivery method decision agent, and an Internet service providing host that connects the client computers to the shopping mall providing server and the delivery method decision agent on the network. The shopping mall providing server includes a shopping mall database, a shopping mall management module, a product database, a settlement management module, and a settlement database. The delivery method decision agent includes a delivery information database.

In another aspect of the present invention, there is provided a delivery optimization method in which a purchaser accesses a network via a computer to buy shopping items. The delivery optimization method includes: (1) presenting delivery methods of a corresponding item when the purchaser selects a desired shopping item and a quantity of the item; and (2) causing the purchaser to select one of the delivery methods and determine whether to place an order for the item at the final price including a delivery rate based on the selected delivery method and a product price. The delivery methods of (2) include joint delivery in which the purchaser takes the shopping item from the warehouse in person, and destination delivery in which a shopping mall provider delivers the shopping item to a destination as desired by the purchaser.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a schematic view of an entire delivery optimization system according to the present invention;

FIG. 2 is a flow chart of a delivery optimization method according to the present invention;

FIG. 3 is a flow chart showing a procedure for determining a delivery rate based on the delivery means in the present invention;

FIG. 4 is an exemplary view of a combo box for the entry of a destination in the present invention;

FIG. 5 is a schematic view showing an example of a database according to the present invention; and

FIG. 6 is a schematic view showing another example of a database according to the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

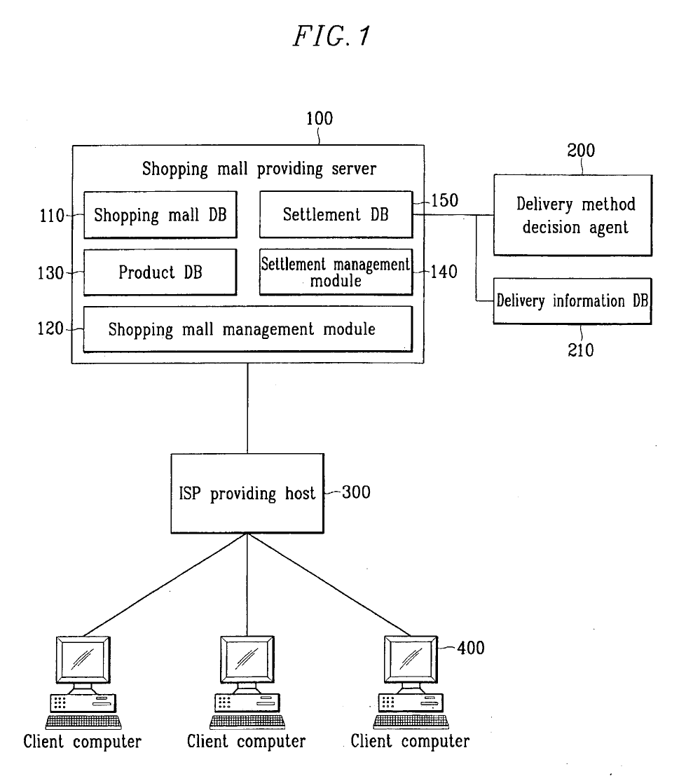

FIG. 1 is an illustration of a delivery optimization system according to an embodiment of the present invention.

As shown in FIG. 1, a commercial transaction system using quantity-based differential unit costs according to the embodiment of the present invention includes a shopping mall providing server 100, a delivery method decision agent 200, an Internet service providing host 300, and a plurality of client computers 400.

The shopping mall providing server 100, the delivery method decision agent 200 and the plural client computers 400 are connected to each other over the network via the Internet service providing host 300 to establish a communication path. The shopping mall providing server 100 includes a shopping mall database 110, a shopping mall management module 120, a product database 130, and a settlement management module 140. The shopping mall providing server 100 may further include a settlement management database 150.

The shopping mall database 110 stores various data necessary to constitute a shopping mall.

The shopping mall management module 120 presents information including items for sale, item-based available warehouse, item-based selling unit, content of shopping cart, whether to select joint delivery or destination delivery as a delivery method, delivery rate based on the delivery means, final shopping price, and the like, and receives entries of shopping items, quantity of each item, whether to select joint delivery or destination delivery as a delivery method, available warehouse, desired delivery means, and the like from the purchaser. The shopping mall management module 120 also causes the purchaser to input a desired destination for the items when the purchaser chooses destination delivery as a delivery method. In inputting the destination, the purchaser is urged to select a combo box for input of province, city and township or a combo box for entry of city and ward. An example of the destination entry combo box is shown in FIG. 4. Alternatively, when the purchaser chooses joint delivery as a delivery method, the shopping mall management module 120 presents available warehouses based on the shopping items and causes the purchaser to input a desired warehouse.

The product database 130 stores data about sell items, quantity unit of each sell item, and available warehouses.

The settlement management module 140 manages settlement of accounts for the shopping items that the purchaser ordered in the virtual shopping mall.

The settlement management database 150 stores data received from the purchaser, including ordered shopping items, item-based quantity and unit cost, available warehouse, warehouse code, location code of the warehouse, and the like. If the purchaser chose destination delivery as a delivery method, the settlement management database 150 may store data concerning delivery rates based on selection of single car delivery delivery, express delivery, ordinary freight, or no-box delivery means.

The delivery method decision agent 200 receives data from a delivery information database 210 based on the shopping item ordered by the purchaser, and determines the delivery rate based on the delivery means from the data of the delivery information database 210. Upon entry of joint delivery as a delivery method from the shopping mall management module 120, the delivery method decision agent 200 calculates delivery rates based on single car delivery, express delivery, ordinary freight, or no-box delivery means, and presents the optimum delivery means to the purchaser via the shopping mall management module 120.

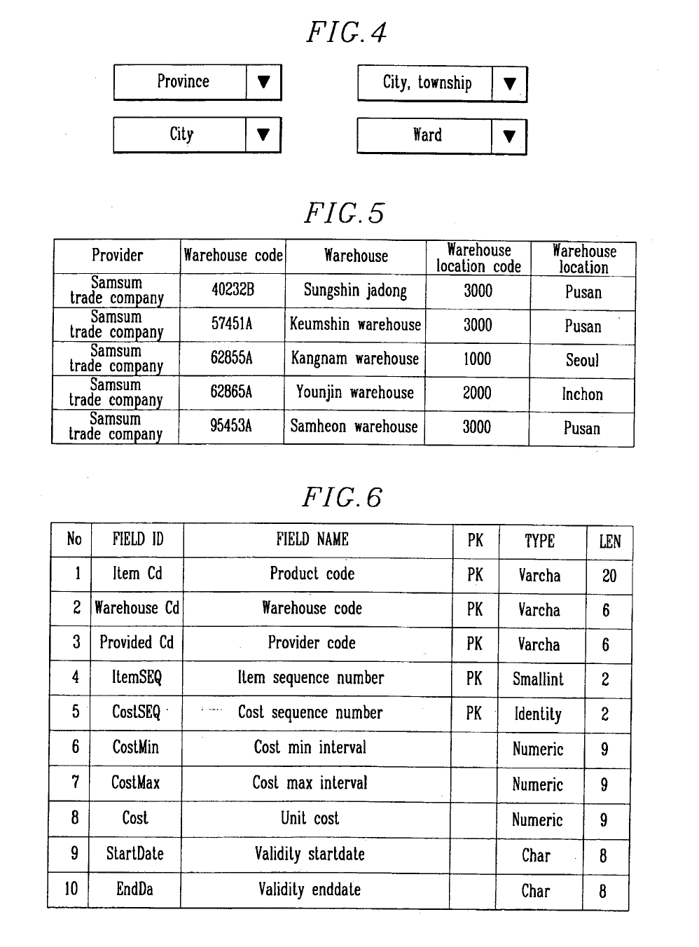

The delivery information database 210 includes data about item-based unit, provider, warehouse name, warehouse location, and warehouse location code, and delivery data groups based on the departure place and the destination by single car delivery, express delivery, ordinary freight, or no-box delivery. An example of the database is shown in FIG. 5.

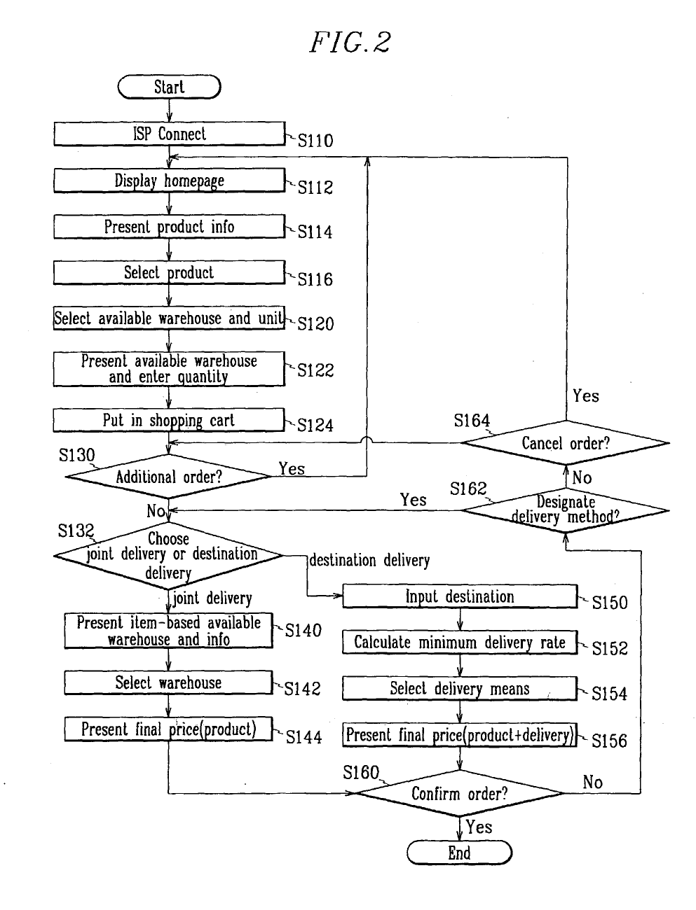

FIG. 2 is a flow chart of a delivery optimization method according to an embodiment of the present invention.

Referring to FIG. 2, a purchaser drives a web browser of the client computer 400 to access the shopping mall providing server 100 via an Internet service providing host, in step s110.

Thus a home page supplied from the shopping mall providing server 100 is displayed on the web browser of the purchaser, in step s112. The shopping mall providing server 100 presents product information to the web browser of the client computer 400 via the shopping mall management module 120, in step s114. The purchaser selects a desired shopping item available in the web browser, in step s116.

The shopping mall providing server 100 ascertains available warehouse data and selling units related to the selected shopping item from the database 130, in step s120, and sends the data to the web browser of the purchaser via the shopping mall management module 120. Once the purchaser inputs the quantity of a desired shopping item, the shopping mall providing server 100 stores the entry in the settlement database 150 via the shopping mall management module 120, in step s122.

The shopping mall providing server 100 queries the purchaser whether to put the desired shopping item in the shopping cart and place an additional order. If the purchaser wants an additional order, the flow of the procedure returns to the step of presenting the product information to the purchaser via the shopping mall management module 120, in step s130. If not, the delivery method of the shopping item is determined. The delivery method includes joint delivery whereby the purchaser directly takes a shopping item from the warehouse in person, and destination delivery is whereby the article is delivered to a desired destination. In joint delivery, the shopping price includes the price of the item alone. But the shopping price with destination delivery includes the delivery rate as well as the price of the item.

When the purchaser chooses joint delivery as a delivery method, the shopping mall management module 120 sends information about the available warehouse of the shopping items, stored in the settlement database 150, to the web browser of the purchaser, in step s140. Warehouse information may include the address, map and telephone number of the warehouse. If the purchaser selects a desired warehouse and sends warehouse data, in step s142, the shopping mall management module 120 sends settlement data including the shopping price to the web browser of the purchaser, in step s144.

When the purchaser chooses destination delivery as a delivery method, the purchaser is urged to input a desired destination for the item, in step s150. The delivery method decision agent 200 determines a delivery rate based on the delivery means using data about shopping items, quantity, unit cost and available warehouse and sends the resulting data to the web browser of the purchaser via the shopping mail management module 120, in step s152. The purchaser selects a specific delivery means and sends the entry to the shopping mall providing server 100, in step s154. The shopping mall providing server 100 sends settlement data including the shopping price and the delivery rate based on the selected delivery means to the web browser of the purchaser, in step s156.

After receiving the final settlement data, the purchaser is queried whether to confirm the order of the item, in step s160. If the purchaser wants to order the item, the purchase of the item using the delivery optimization system is completed. Otherwise, if the purchaser does not want to order the item, the shopping mall providing server 100 urges the purchaser to designate the delivery method again, in step s162, and if the purchaser chooses not to, a query as to whether to cancel the order is given in step s164. If the answer is affirmative, the settlement data in the settlement database 150 is deleted, and the shopping mall providing server 100 displays the home page on the web browser of the purchaser, in a return to step s112.

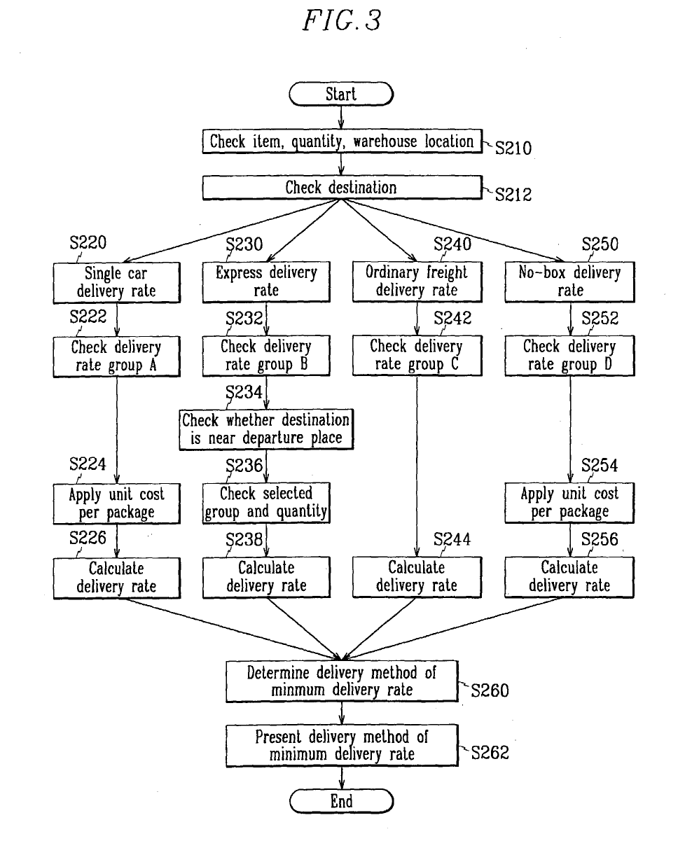

FIG. 3 is a flow chart showing a procedure for determining the minimum delivery rate in the case of destination delivery.

Referring to FIG. 3, the purchaser enters data about desired shopping item, quantity, unit cost and destination, in step s210, and checks an available warehouse of the corresponding item from the database 130, in step s212. As the data are stored in the settlement database 150, the delivery rate based on the delivery means, i.e., single car delivery, express delivery, ordinary freight or no-box delivery, is retrieved from the data.

For single car delivery, the system retrieves the delivery rate data group for single car delivery from the database 210, in step s222, and determines the delivery rate by applying the unit cost per package to the data, in steps s224 and s226.

For express delivery, the system retrieves the delivery rate data group for express delivery from the database 210, in step s232, and checks whether the destination is near the departure place. If the destination is near the departure place, the system selects the delivery rate for the near destination delivery rate data group, in step s234, and calculates the optimum delivery rate from the delivery rate data of the selected group and the quantity of items.

For ordinary freight, the system retrieves the delivery rate data group for ordinary freight from the database 210, in step s242, and calculates the delivery rate from the delivery rate data group, in step s244. The delivery rate data group for ordinary freight may exist off-line.

For no-box delivery, the system retrieves the delivery rate data group for no-box delivery from the database 210, in step s252, and applies the unit cost per package to the delivery rate data group to determine the delivery rate, in step s256.

Subsequently, the system compares the delivery rates based on the delivery means to determine the optimum delivery means that costs the least, and sends the result of the decision to the web browser of the purchaser.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

The transaction system and method according to the present invention have the following effects.

First, the purchaser gains an opportunity to choose the optimum delivery means for electronic commercial transactions over the Internet network.

Second, the above effect reduces a burden of delivery rate for the purchaser for electronic commercial transactions on the Internet.

Finally, the above effects reduce the entire shopping price of the items.

What is claimed is:

1. A delivery optimization system, in which a purchaser accesses a network via a computer to input shopping items and quantity of the items, the delivery optimization system comprising:
a shopping mall providing server for receiving shopping items and quantity of items input by the purchaser, and providing a shopping mall that enables the purchaser to execute a commercial transaction;
a delivery information database for storing delivery information including delivery methods and delivery rates of the items provided in the shopping mall; and
a delivery method decision agent for determining an optimum delivery method using the delivery information of the delivery information database when the purchaser chooses the delivery method of the shopping item.

2. The delivery optimization system as claimed in claim 1, wherein the shopping mall providing server provides product information including items, and item-based selling unit and price to the shopping mall.

3. The delivery optimization system as claimed in claim 1, wherein the delivery information database includes warehouse information, delivery rate information, and delivery method information.

4. The delivery optimization system as claimed in claim 1, wherein the shopping mall management module causes the purchaser to enter a desired destination of the shopping item when the purchaser chooses destination delivery as a delivery method.

5. The delivery optimization system as claimed in claim 4, wherein the delivery method decision agent determines the delivery rates based on the delivery means including single car delivery, express delivery and ordinary freight for shopping items, quantity of the items, and destination input by the purchaser.

6. The delivery optimization system as claimed in claim 5, wherein the delivery method decision agent determines a delivery means of the minimum delivery rate.

7. The delivery optimization system as claimed in claim 1, wherein a shopping mall management module causes the purchaser to input a desired one of available warehouses based on the shopping item when the purchaser chooses joint delivery as a delivery method.

8. A delivery optimization method, in which a purchaser accesses a network via a computer to buy shopping items, the delivery optimization method comprising:
(1) presenting delivery methods of a corresponding item when the purchaser selects a desired shopping item and a quantity of the item; and
(2) causing the purchaser to select one of the delivery methods and determine whether to place an order for the item at the final price including a delivery rate based on the selected delivery method and product price.

9. The delivery optimization method as claimed in claim 8, wherein the delivery methods of (2) include joint delivery in which the purchaser takes the shopping item from the warehouse in person, and destination delivery in which a shopping mall provider delivers the shopping item to a destination as desired by the purchaser.

10. The delivery optimization method as claimed in claim 9, further comprising (3) presenting item-based available warehouses and causing the purchaser to select a desired warehouse when the purchaser chooses joint delivery as a delivery method.

11. The delivery optimization method as claimed in claim 9, further comprising, when the purchaser chooses destination delivery as a delivery method:
(4) causing the purchaser to input a desired destination for the item;
(5) calculating delivery rates based on the delivery means including single car delivery, express delivery, ordinary freight and no-box delivery from the data about shopping item, quantity and destination input by the purchaser; and
(6) determining a delivery means of the minimum delivery rate.

12. The delivery optimization method as claimed in claim 11, wherein (5) comprises, in determination of the delivery rate for single car delivery:
(7) checking a delivery rate data group for single car delivery;
(8) checking whether the destination is near a departure place;
(9) applying a unit cost per package; and
(10) calculating the delivery rate for single car delivery based on the data group and the unit cost.

13. The delivery optimization method as claimed in claim 11, wherein (5) comprises, in determination of the delivery rate for express delivery:
(11) checking a delivery rate data group for express delivery;
(12) checking the quantity of the item based on the selected data group; and
(13) calculating the delivery rate for express delivery based on the data.

14. The delivery optimization method as claimed in claim 11, wherein (5) comprises, in determination of the delivery rate for ordinary freight:
(14) checking a delivery rate data group for ordinary freight; and
(15) calculating the delivery rate for ordinary freight based on the data.

15. The delivery optimization method as claimed in claim 11, wherein (5) comprises, in determination of the delivery rate for no-box delivery:
(16) checking a delivery rate data group for no-box delivery; and
(17) calculating the delivery rate for no-box delivery based on the data.
